(19) United States
(12) Patent Application Publication
(10) Pub. No.: US 2016/0314122 A1
(43) Pub. Date: Oct. 27, 2016

(54) IDENTIFYING EXPERTS AND AREAS OF EXPERTISE IN AN ORGANIZATION

(71) Applicant: MICROSOFT TECHNOLOGY LICENSING, LLC., Redmon, WA (US)

(72) Inventors: Manolis Platakis, Oslo (NO); Christos Makris, Oslo (NO); Thorbjorn Tonnesen Lied, Larvik (NO); Berit Herstad, Oslo (NO); Stamatina Thomaidou, Athens (GR); Slavko Zitnik, Ljubljana (SI)

(73) Assignee: MICROSOFT TECHNOLOGY LICENSING, LLC., Redmond, WA (US)

(21) Appl. No.: 14/695,822

(22) Filed: Apr. 24, 2015

(51) Int. Cl. G06F 17/30

(52) U.S. Cl. CPC G06F 17/3053

(57) ABSTRACT

Automatic identification of experts and areas of expertise in an organization is provided. An analysis processing engine retrieves data from various data repositories, preprocesses the data, and employs algorithms for recognition of words and phrases from which a top number of phrases are selected as areas of expertise. The analysis processing engine stores the selected areas of expertise in a graph structure. Once one or more areas of expertise are identified and stored in the graph structure, the analysis processing engine queries the graph structure for identification and ranking of experts on the one or more areas of expertise. Bidirectional graph edges are added between the areas of expertise nodes and the corresponding experts of the areas of expertise such that both targeted and exploratory queries are enabled.

### BACKGROUND

Generally, an expert is a person who has knowledge or ability in a particular area of study beyond that of an average person. Oftentimes in an organization, employees benefit from or require assistance from experts in the organization who have knowledge or ability in a particular area of expertise. However, it can be difficult to know who the expert is in a particular subject matter, especially in a large or distributed organizational setting.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects of the present disclosure are directed to an automated system and method for identifying experts and areas of expertise in an organization. An expert and expertise identification system comprises an analysis processing engine communicatively attached to various data repositories from which it retrieves data, preprocesses the data, and employs algorithms for recognition of words and phrases from which a top number of phrases are selected as areas of expertise. The analysis processing engine stores the selected areas of expertise in a graph structure.

Once one or more areas of expertise are identified and stored in the graph structure, for each area of expertise, the analysis processing engine queries the graph structure for identification and ranking of experts on the one or more areas of expertise. Bidirectional graph edges are added between the areas of expertise nodes and the corresponding experts of the areas of expertise such that both targeted and exploratory queries are enabled. For example, a user is enabled to query the graph for an expert of topic “A,” or for which area(s) of expertise does user “X” hold. Users are therefore able to quickly and easily identify experts of a given subject matter and areas of expertise that a colleague holds. Accordingly, aspects of the expert and expertise identification system help to increase users' efficiency by enabling users to spend less time searching for and locating experts in an organization. Additionally, the expert and expertise identification system encourages sharing of knowledge and collaboration across the organization, and thus benefits users with knowledge from experts of which the users may not have been aware.

According to an aspect, examples are implemented as a computer process, a computing system, or as an article of manufacture such as a computer program product or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a simplified block diagram of a system for identifying experts and areas of expertise in an organization;

FIG. 2 is a simplified block diagram illustrating components of an analysis processing engine;

FIG. 3 is an example illustration of a graph structure comprising an expert node, an area of expertise node, and a bidirectional edge connected the two nodes;

FIGS. 4A and 4B illustrate an operational flow for identifying experts and areas of expertise in an organization;

FIG. 5 is a block diagram illustrating example physical components of a computing device with which implementations may be practiced;

FIGS. 6A and 6B are simplified block diagrams of a mobile computing device with which implementations may be practiced; and

FIG. 7 is a simplified block diagram of a distributed computing system in which implementations may be practiced.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

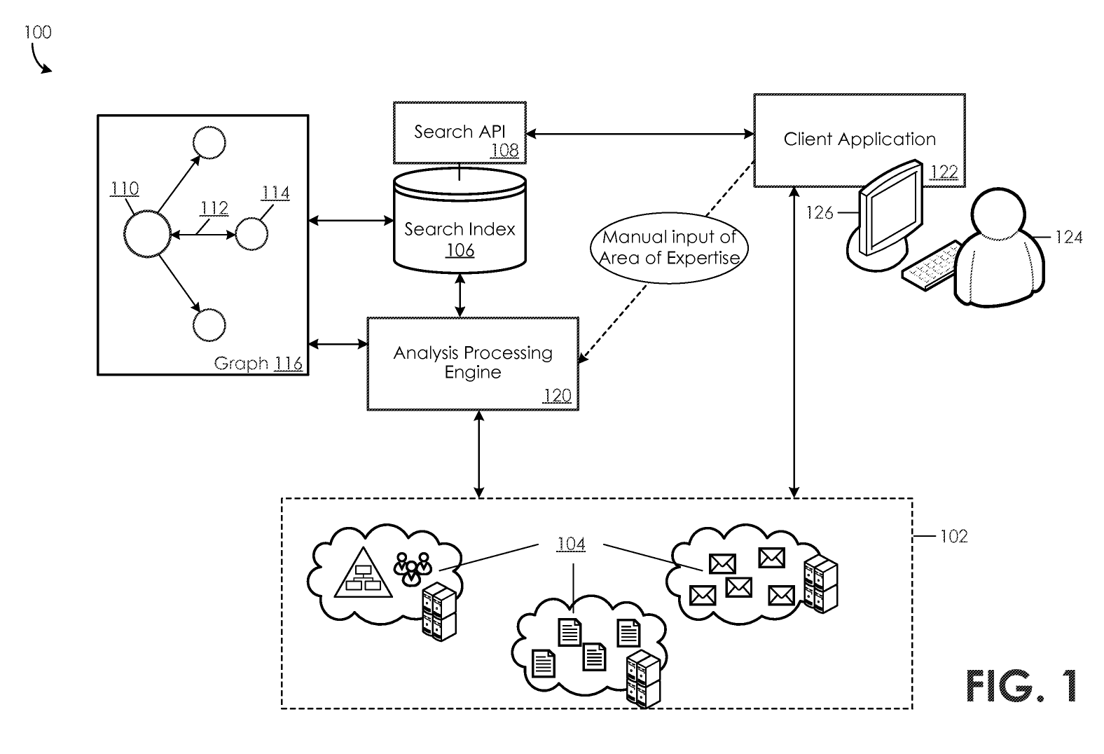

Aspects of the present disclosure are directed to identifying experts and areas of expertise in an organization. FIG. 1 is a simplified block diagram of one example of an expert and expertise identification system 100. As illustrated in FIG. 1, an analysis processing engine 120 analyzes a variety of information items 104 from the various data repositories 102 for identification of words or phrases as potential area of expertise candidates. Data repositories 102 may include remote servers, local or remote databases, local or remote shared resources repositories, social networking service servers, and the like. The data repositories 102 store various types of information items 104, such as documents, images, data files, video files, audio files, meeting items, communication items, such as electronic mail items, text messages, telephone messages, posts, blogs, and the like.

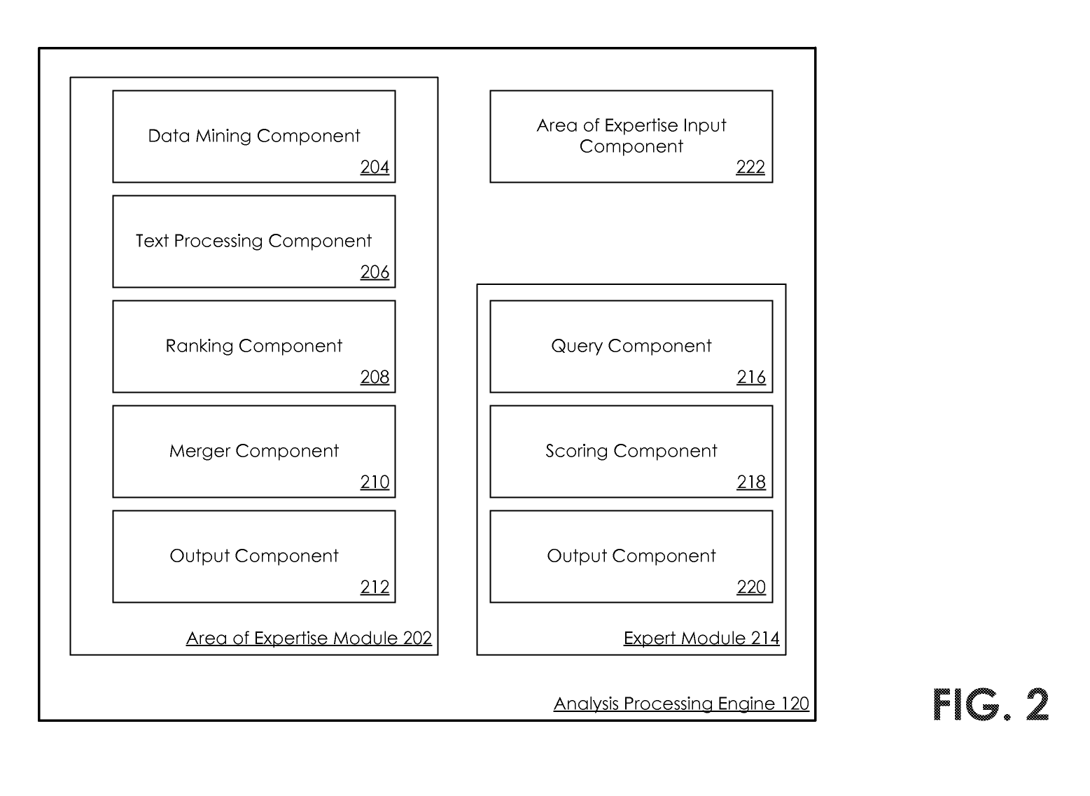

The analysis processing engine 120, as will be described in greater detail with respect to FIG. 2, is operable to gather area of expertise candidates from analysis of the information items 104 stored in the various data repositories 102, rank the area of expertise candidates, and push the top N ranking words or phrases to a search index 106 for storage in the graph structure 116 as independent nodes. According to another aspect, the analysis processing engine 120 is operable to receive manual area of expertise input from a user 124 via a client application 122 running on or in communication with computing device 126, such as a desktop computer, laptop computer, tablet-style computer, handheld computing device, mobile communication device, and the like. For example, the user 124 can enter a word or phrase as an area of expertise via the client application 122 and the analysis processing engine 120 for storage in the graph structure 116.

The analysis processing engine 120 is further operable to query the data repositories 102 for information items 104 comprising the area of expertise words or phrases for identifying experts of the areas of expertise, and represent the relationship between an identified expert and the expert's areas of expertise via a bidirectional edge in the graph structure 116.

The graph structure 116 includes information about enterprise information items 104, such as people and documents and the relationships and interactions among the information items 104. The information items 104 are represented as nodes 110,114, and the relationship and interactions are represented as edges 112. Edges 112 represent a single interaction (e.g., a colleague modified a document, the user viewed an image, etc.), are representative of multiple interactions (e.g., people with whom the user frequently interacts, items that are popular in the user's circle of colleagues, etc.), or represent an organizational relationship (e.g., manager, colleague, etc.). According to aspects of the present disclosure, an edge 112 can represent an expertise relationship (e.g., user X is an expert in area of expertise A or area of expertise A is held by a user X). Each information item, interaction, and relationship represented by the nodes 110,114 and edges 112 comprises a plurality of attributes. The attributes of the nodes 110,114 and edges 112 are parsed and maintained in the search index 106, which may be maintained by one or more servers.

A user 124 is enabled to perform a search query on the search index 106 via a search application programming interface (API) 108, which enables the client application 122 to communicate with the search index 106 for retrieving expertise information from the graph structure 116. According to an aspect, the client application 122 is a software application containing sufficient computer executable instructions for generating a content feed of information items 104 surfaced to a user, for example, a search and presentation application. The client application 122 is operable to present a search field to the user 124 via a user interface for requesting information from the graph structure 116. For example, the user 124 may be tasked with an assignment relating to the subject of “electrical safety,” the subject of which the user is not an expert. The user 124 may wish to find someone in his/her organization who is an expert on “electrical safety.” Accordingly, the user 124 may submit a query via the search field in the client application 122 user interface for an expert on “electrical safety.” The client application 122 may send an application programming interface (API) call to the search index 106 for an expert on “electrical safety.”

The search index 106 may return a reply comprising the name of a colleague identified as an expert on “electrical safety.” According to an aspect, various attributes associated with the expert in the graph structure 116 are included in the reply. The client application 122 generates an element for display in the user interface including the various attributes associated with the expert, for example, an email address, a username, a title, an email address, phone number, etc. A link may be generated and included with the element, which when selected, allows the user to navigate to a page associated with the expert, wherein the page may comprise such information as colleagues of the expert and a selection of information items 104 that are popular among the expert and the expert's colleagues.

With reference now to FIG. 2, a simplified block diagram illustrating various components and modules of the analysis processing engine 120 is provided. According to an aspect, the various components and modules of the analysis processing engine 120 operate over distributed systems (e.g., cloud-based computing systems), where application functionality, memory, data storage and retrieval and various processing functions are operated remotely from each other over a distributed computing network, such as the Internet or an intranet. According to another aspect, the various components and modules of the analysis processing engine 120 are deployed on a single computer.

As illustrated, the analysis processing engine 120 comprises an area of expertise module 202 operable to identify one or more areas of expertise in an organization. The area of expertise module 202 comprises a data mining component 204 for retrieving textual data associated with the corpus of information items 104 stored in the various data repositories 102. The data mining component 204 is operable to communicate with each of the various data repositories 102, the search index 106, or the graph 116 for retrieving textual data associated with the information items 104. According to an aspect, the data mining component 204 retrieves textual data included in titles of the information items 104. According to another aspect, the data mining component 204 retrieves textual data included in bodies of the information items 104. The textual data can be received by the data mining component 204 via a push or pull system. According to an aspect, the data mining component 204 runs continually so that it is operable to react to existing content in the data repositories 102, as well as to incoming information items 104.

The area of expertise module 202 further comprises a text processing component 206 for analyzing the textual data and for transforming the corpus of textual data into a set of words which can be used as input for further processing. According to an aspect, the text processing component 206 employs a tokenization process to break up a string of text into words, phrases, symbols, or other meaningful elements called tokens. According to another aspect, the text processing component 206 employs a lemmatization process to reduce inflectional forms of words and sometimes derivationally related forms of words to a common base form (e.g., reduce “am,” “are,” and “is” to “be”), as well as relating words via thesaurus operators (e.g., matching “hot” to “warm”). According to another aspect, the text processing component 206 employs a stopwords removal process for removing certain words from the textual data, for example, common short function words, such as “the,” “is,” “at,” “which,” and “on.”

As illustrated, the area of expertise module 202 further comprises a ranking component 208 for identifying relevant words and phrases as candidates for areas of expertise. According to an aspect, the ranking component 208 employs a term frequency-inverse document frequency (IF-IDE) algorithm for producing a composite weight for each word in the set of words provided by the text processing component 206, wherein the TF-IDF value increases proportionally to the number of times a word appears in the document (information item 104), but is offset by the frequency of the word in the corpus of documents.

According to an example, the TF-IDF value is the product of two statistics: the term frequency (TF) and the inverse document frequency (IDF), where the TF is computed as the number of times a word appears in an information item 104 divided by the total number of words in that information item 104, and the IDF is computed as the logarithm of the number of information items 104 in the corpus divided by the number of information items 104 where the specific term appears.

The term frequency (TF) measures how frequently a term occurs in an information item 104. Since every an information item 104 is different in length, it is possible that a term would appear much more times in longer information items 104 than shorter ones. Thus, the TF is divided by the information item 104 length (i.e., the total number of terms in the information item 104) as a way of normalization:

TF(t)=(Number of times term t appears in a document)/(Total number of terms in the document).

The Inverse Document Frequency (IDF) measures how important a term is. While computing TF, all terms are considered equally important. However it is known that certain terms, such as “is”, “of”, and “that”, may appear often, but have little importance. Thus, the frequent terms are weighed down, and the rare terms are scaled up, by computing the following:

IDF(t)=log_e(Total number of documents/Number of documents with term t in it).

For example, consider an information item 104 containing 100 words wherein the word “computer” appears 3 times. The TF for “computer” is:

$$( \frac{3}{100} ) = 0.03 .$$

Now, assume there are 10 million information items 104 in the corpus, and the word “computer” appears in one thousand of these. Then, the IDF is calculated as:

$$log ( \frac{10 , 000 , 000}{1 , 000} ) = 4.$$

Thus, the TF-IDF value is the product of these quantities is: 0.03×4=0.12. As should be appreciated, the above is a simplified TD-IDF function. Other variants of this simple model may be utilized by the ranking component for identifying relevant words and phrases in an information item 104 as candidates for areas of expertise terms.

According to an aspect, the ranking component 208 employs a statistical word co-occurrence (WordCo) algorithm for keyword extraction, which determines an importance of a term in a document (information item 104) without requiring the use a corpus of documents. The WordCo algorithm extracts a set of frequent terms by counting term frequencies, and builds a co-occurrence matrix by counting co-occurrences of each term and each frequent term in a sentence. If the probability distribution of co-occurrence between a term and the frequent terms is biased to a particular subset of frequent terms, then the term is determined as likely to be a keyword. The degree of biases of distribution is measured by a χ2-measure.

According to an example, the WordCo algorithm includes the following steps:

1. Selection of frequent terms: Select the top frequent terms up to 30% of the number of running terms=Ntotal.

2. Clustering frequent terms: Cluster a pair of terms whose Jensen-Shannon divergence is above the threshold (0.95×log 2). Cluster a pair of terms whose mutual information is above the threshold (log(2.0)). The obtained clusters are denoted as C.

3. Calculation of expected probability: Count the number of terms co-occurring with cεC, denoted as nc, to yield the expected probability pc=nc/Ntotal.

4. Calculation of χ2 value: For each term w, count co-occurrence frequency with cεC, denoted as freq(w, c). Count the total number of terms in the sentences including w, denoted as nw. Calculate χ2 value.

5. Output keywords: Show a given number of terms having the largest χ2 value. Important terms are extracted regardless of their frequencies.

According to an aspect, the ranking component 208 employs both a TF-IDF algorithm and a statistical word co-occurrence algorithm for generating sets of important words and phrases. For example, the term frequency—inverse document frequency algorithm and the statistical word co-occurrence algorithm are applied to the title of each information item 104 and to the body of each information item 104. The output of the ranking component 208 includes sets of important words and phrases, for example, a first set of important words and phrases from the titles of information items 104 as determined by the TF-IDF algorithm, a second set of important words and phrases from the bodies of information items 104 as determined by the TF-IDF algorithm, a third set of important words and phrases from the titles of information items 104 as determined by the WordCo algorithm, and a fourth set of important words and phrases from the bodies of information items 104 as determined by the WordCo algorithm. According to an aspect, each word or phrase includes a level of importance, for example, on a level from 0 to 1.

As illustrated, the area of expertise module 202 further comprises a merger component 210 for receiving the output from the ranking component 208 and merging the results. According to an example, the merger component 210 merges the words and phrases using a function operable to calculate the membership values of intersection, union, and complement of fuzzy sets, such as a triangular conorm (T-conorm) function. Once the results are merged, the merger component 210 selects a top N words or phrases as areas of expertise.

The area of expertise module 202 further comprises an output component 212 for passing the selected N areas of expertise to the search index 106, such that each area of expertise can be represented in the graph structure 116 as an independent node 110,114.

With reference still to FIG. 2, the analysis processing engine 120 includes an expert module 214 operable to identify experts of each area of expertise by ranking authors of information items 104 in the organization against an area of expertise. According to an example, the ranking is based on the following concepts: people write documents (information items 104) to communicate information that they know and information items 104 that are read by a lot of people include more valuable information that those information items that do not get as much traction.

As illustrated, the expert module 214 comprises a query component 216 for querying one or more of the data repositories 102, the search index 106, or the graph structure 116 for information items 104 that comprise the area of expertise terms. According to an aspect, the area of expertise terms include the areas of expertise determined by the area of expertise module 202. According to another aspect, the query component 216 is operable to query for information items 104 that comprise an area of expertise term manually entered by a user 124. For example, an area of expertise term may not have been identified by the area of expertise module 202, or may not have been within the top N areas of expertise as determined by the merger component 210 of the area of expertise module 202, Whatever the reason, users 124 are enabled to input an area of expertise term into the system via the client application 122. According to an aspect, the analysis processing engine 120 comprises an area of expertise input component 222, which is operable to receive an input of an area of expertise term from the client application 122, and add the manually inserted area of expertise term into the graph structure 116.

Referring still to FIG. 2, the expert module 214 further comprises a scoring component 218 for generating a score for each author of each information item 104 comprising an area of expertise term. According to an aspect, the score may be an updated score if an author is already associated with an information item 104 in the graph structure 116. According to another aspect, a node 110,114 may be generated for the author and added to the graph structure 116, and a score may be generated for the author if the author is not already associated with the information item 104 in the graph structure 116. The following are example heuristics that may be used by the scoring component 218 to generate a score for each author of each information item 104 comprising an area of expertise term:

For all Documents.Contains(Expertise):
WeightOfDocument=1

if SummaryOfDocument.Contains(Expertise):
WeightOfDocument+=0.2

if TitleOfDocument.Contains (Expertise):
WeightOfDocument+=0.5

for all Authors in Document:
AuthorWeight=WeightOfDocument
if Author is First Author:
   AuthorWeight+=0.5
Author.Value+=AuthorWeight*Document.Views.

According to the above examples, the weight of an information item 104 depends on the following factors: views of the information item 104, whether the summary of the information item 104 includes the area of expertise term, and whether the title of the information item 104 includes the area of expertise term. By using the factors of whether the summary of the information item 104 includes the area of expertise term and whether the title of the information item 104 includes the area of expertise term, the weights of information items 104 that include an area of expertise term but that are not directly related to it are weighted down. Additionally, the first author (i.e., creator or key contributor) of an information item 104 is given a higher score over other authors (e.g., contributors) for the information item 104 under the supposition that the first author is the main contributor to the content of the information item 104. As should be appreciated, other heuristics may be used. For example, if the information item 104 is a social networking post or a document attached to a post, the score is weighted by the number of likes, the number of replies, the number of users who have access to the post, etc. The scoring component 218 is further operable to rank the authors associated with a particular area of expertise by the generated scores, and a subset of top N authors are selected as experts of the particular area of expertise.

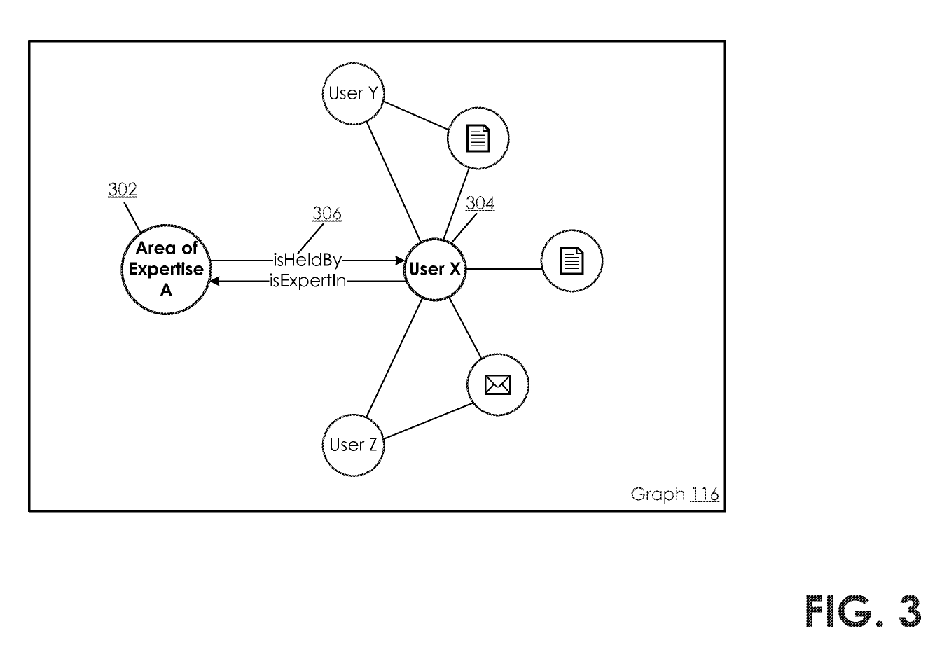

The expert module 214 further comprises an output component 220 for representing associations between the areas of expertise and the selected experts in the graph structure 116 according to the scores generated by the scoring component 218. The output component 220 is operable to pass the scores to the search index 106, such that an expert is associated with an area of expertise via a bidirectional edge 112. The representation of the association between experts and areas of expertise in the graph structure 116 is described in more detail below with respect to FIG. 3.

With reference now to FIG. 3, an example portion of a graph structure 116 is illustrated. The example graph structure 116 includes a first node 302 representative of an area of expertise (Area of Expertise A) as determined by the area of expertise module 202 or manually added by a user 124. The example graph structure 116 further includes a second node 304 representative of a user (User X) determined to be an expert of Area of Expertise A by the expert module 214 as described above. A bidirectional edge 306 connecting the first node 302 and the second node 304 is generated by the expert module output component 220 and added to the graph structure 116 as illustrated. The bidirectional edge 306 enables both a targeted and exploratory user interaction as will be described in the example below.

According to an example, the bidirectional edge 306 includes various properties and property values describing the edge 306. For example, the edge 306 may include one or a combination of the following: an action/relationship type, an ID, a visibility property, a weight, and a timestamp. The action/relationship type is an identifier that identifies what action or relationship type the edge 306 represents. For example, the action/relationship type describes the bidirectional relationship between the first node 302 (Area of Expertise A) and the second node 304 (User X): “isHeldBy” and “isExpertIn.” Accordingly, a query on the graph structure 116 via the search AH 108 for who an expert is on Topic A will generate a response of: Person:UserX-isExpertIn-AreaOfExpertise:A. Additionally, a query for which area (s) of expertise does User X hold will generate a response of: AreaOfExpertise:A-isHeldBy-Person:UserX.

Having described an operating environment and various aspects with respect to FIGS. 1-3, FIGS. 4A and 4B illustrate a method for identifying experts and areas of expertise in an organization. The routine 400 begins at start OPERATION 405 and proceeds to ASYNCHRONOUS OPERATION 410, where the graph structure 116 tracks and stores organizational entities (e.g., information items 104, users 124, etc.) and the relationships between them as nodes 110,114 and edges 112 in the search index 106. For example, when a user 124 creates or authors a document (information item 104), nodes 110,114 are generated and stored for the user 124 and the document, and an edge 112 connecting the user 124 and the document representative of the “create” interaction is generated and stored in the graph structure 116.

The routine 400 advances to DECISION OPERATION 415, where a determination is made as to whether a user 124 has manually input of an area of expertise term into the system. For example, a determination is made as to whether a user 124 has entered a topic as an area of expertise via the client application 122. If a determination is made that an area of expertise term has been manually input by a user 124, the routing 400 advances to OPERATION 420, where the area of expertise input component 222 receives the input from the client application 122. At OPERATION 455, the area of expertise term is added to the graph structure 116 as a node 302.

If a determination is made that an area of expertise term has not been manually input by a user 124, the routine 400 advances to OPERATION 425, where the data mining component 204 of the area of expertise module 202 communicates with various data repositories 102, the search index 106, and the graph 116, and retrieves textual data associated with information items 104. For example, the data mining component 204 retrieves textual data included in titles of the information items 104 and in bodies of the information items 104. According to an aspect, the data mining component 204 parses information items 104 of a certain format, for example, word processing files, slide presentation files, fixed layout documents (e.g., PDF files), and ASCII text-formatted data files. The textual data may be received by the data mining component 204 via a push or pull system.

The routine 400 advances to OPERATION 430, where the text processing component 206 analyzes the textual data retrieved by the data mining component 204, and applies one or more preprocessing functions for transforming the corpus of textual data into a set of terms that can be used as input for further processing. For example, the text processing component 206 employs one or more of: tokenization, lemmatization, and stopwords removal.

The routine 400 advances to OPERATION 435, where the ranking component 208 generates a subset of relevant words and phrases as candidate area of expertise terms. According to an aspect, the ranking component 208 employs one or more ranking functions, for example, the term frequency inverse document frequency algorithm and the statistical word co-occurrence algorithm, for identifying important words and phrases. The output of the ranking component 208 includes sets keywords and keyphrases and a level of importance for each keyword and keyphrase. According to an aspect, the sets include a TF-IDF title set, a TF-IDF body set, a WordCo title set, and a WordCo body set.

The routine 400 advances to OPERATION 440, where the merger component 210 merges the sets of keywords and keyphrases into a single set, wherein the keywords and keyphrases are ranked. According to an aspect, the merger component 210 uses a T-conorm function to merge the sets of keywords and keyphrases. Once the sets are merged, the routine 400 advances to OPERATION 445, where the merger component 210 selects a top N keywords or keyphrases from the merged set as area of expertise terms.

At OPERATION 450, the output component 212 of the area of expertise module 202 passes the selected N area of expertise terms to the search index 106, and at OPERATION 455, each area of expertise term is represented in the graph structure 116 as an independent node 302.

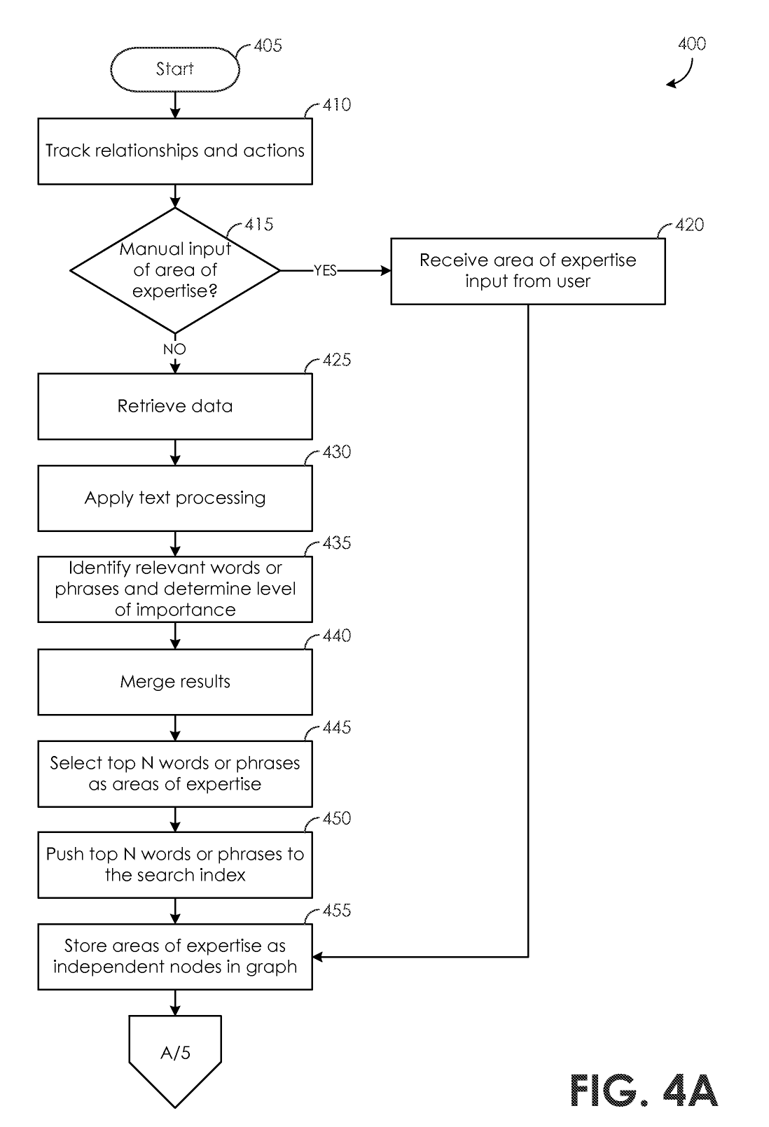

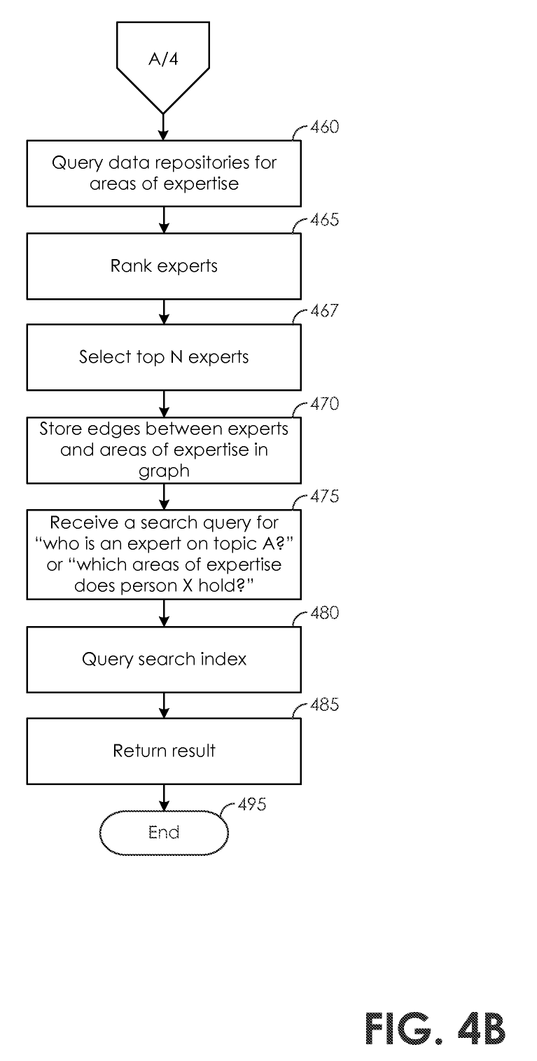

With reference now to FIG. 4B, the routine 400 advances to OPERATION 460, where the query component 216 of the expert module 214 queries one or more of the data repositories 102, the search index 106, or the graph structure 116 for information items 104 that comprise the area of expertise terms. According to an aspect, the area of expertise terms may include the area of expertise terms determined by the area of expertise module 202 and area of expertise terms manually entered by a user 124.

The routine 400 advances to OPERATION 465, where the scoring component 218 generates a score for each author of each information item 104 comprising an area of expertise term according to various heuristics as described above, and ranks the authors associated with each area of expertise by the generated scores. At OPERATION 467, the scoring component 218 selects a top N authors as experts of each area of expertise.

The routine 400 advances to OPERATION 470, were the output component 220 of the expert module 214 passes the associations between experts and areas of expertise to the graph structure 116 for representing the associations between the areas of expertise nodes 302 and the selected experts nodes 304 as bidirectional edges 306. The edges 306 are stored with weight information in addition to what is already written, that is, the expert rankings are persisted.

At OPERATION 475, an indication of a search query is received. For example, a user 124 may use the client application 122 to search for “who is an expert on topic A?” or “which areas of expertise does person X hold?”

The routine 400 advances to OPERATION 480, where the client application 122 makes an API call via the search API 108 to the search index 106 for querying the search index 106 for graph edges 306 satisfying the query. For example, if the query is for “who is an expert on topic A,” the search API 108 queries the search index 106 for an “AreaofExpertise:A—isHeldBy—Person:X” edge 306.

At OPERATION 485, the result of the query, an ordered list of experts based on weight, is returned to the client application 122. According to an aspect, the client application 122 generates an element for display in a user interface including the various attributes associated with the expert or experts, for example, an email address, a username, a title, an email address, phone number, etc. A link may be generated and included with the element, which when selected, allows the user 124 to navigate to a page associated with the expert, wherein the page may comprise such information as colleagues of the expert and a selection of information items 104 that are popular among the expert and the expert's colleagues.

The routine 400 ends at OPERATION 495.

Examples of the expert and expertise identification system 100 provide for: receiving textual data associated with a corpus of information items 104; transforming the textual data into a set of terms which can be used as input for further processing; processing the set of terms to generate a ranked set of keywords or keyphrases, and selecting a subset of the ranked set of keywords or keyphrases as one or more areas of expertise; storing each of the one or more areas of expertise as a node 302 in a graph structure 116; performing a query for information items 104 associated with each of the one or more areas of expertise; generating a score for each author of each information item associated with each of the one or more areas of expertise; ranking the authors associated with the one or more areas of expertise; selecting a subset of top ranking authors associated with each of the one or more areas of expertise; generating and storing a node 304 for each of the top ranking authors associated with each of the one or more areas of expertise in the graph structure 116 if a node does not already exist; and generating and storing bidirectional edges 306 connecting each of the nodes 304 representing the top ranking authors with the corresponding area of expertise nodes 302 in the graph structure 116.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

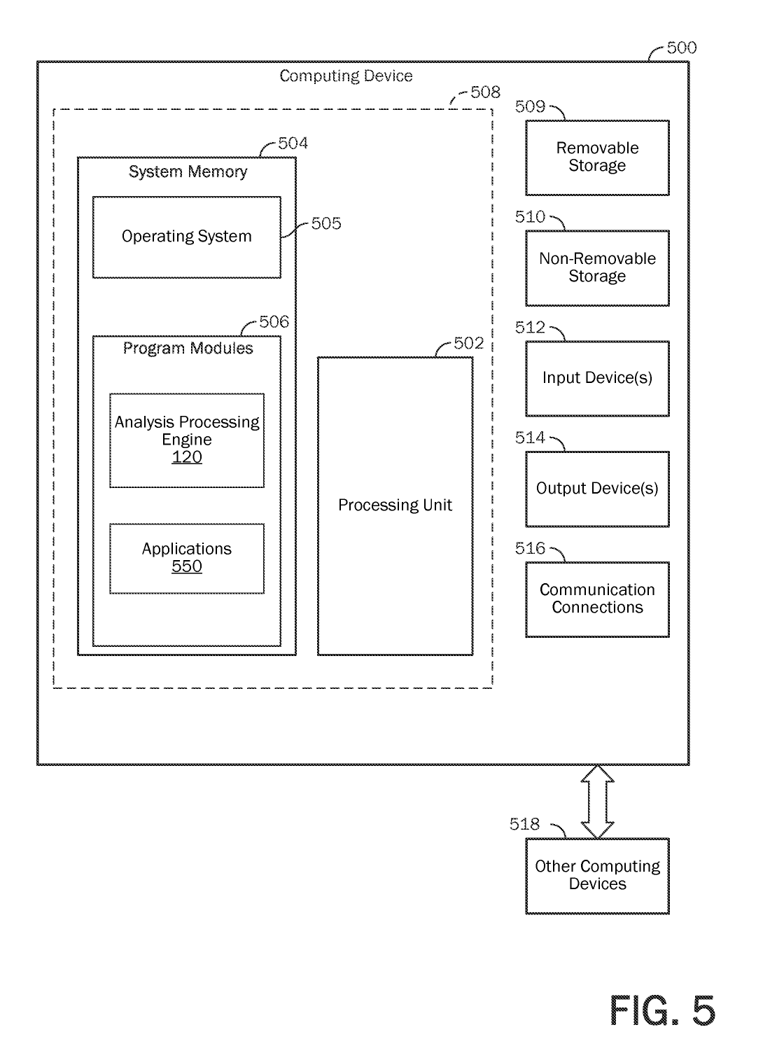

FIG. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are utilized for practicing aspects, described herein.

FIG. 5 is a block diagram illustrating physical components (i.e., hardware) of a computing device 500 with which examples of the present disclosure are be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more programming modules 506 suitable for running software applications 550. According to an aspect, the system memory 504 includes the analysis processing engine 120. The operating system 505, for example, is suitable for controlling the operation of the computing device 500. Furthermore, aspects are practiced in conjunction with a graphics library, other operating systems, or any other application program, and is not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., analysis processing engine 120) perform processes including, but not limited to, one or more of the stages of the method 400 illustrated in FIGS. 4A and 4B. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

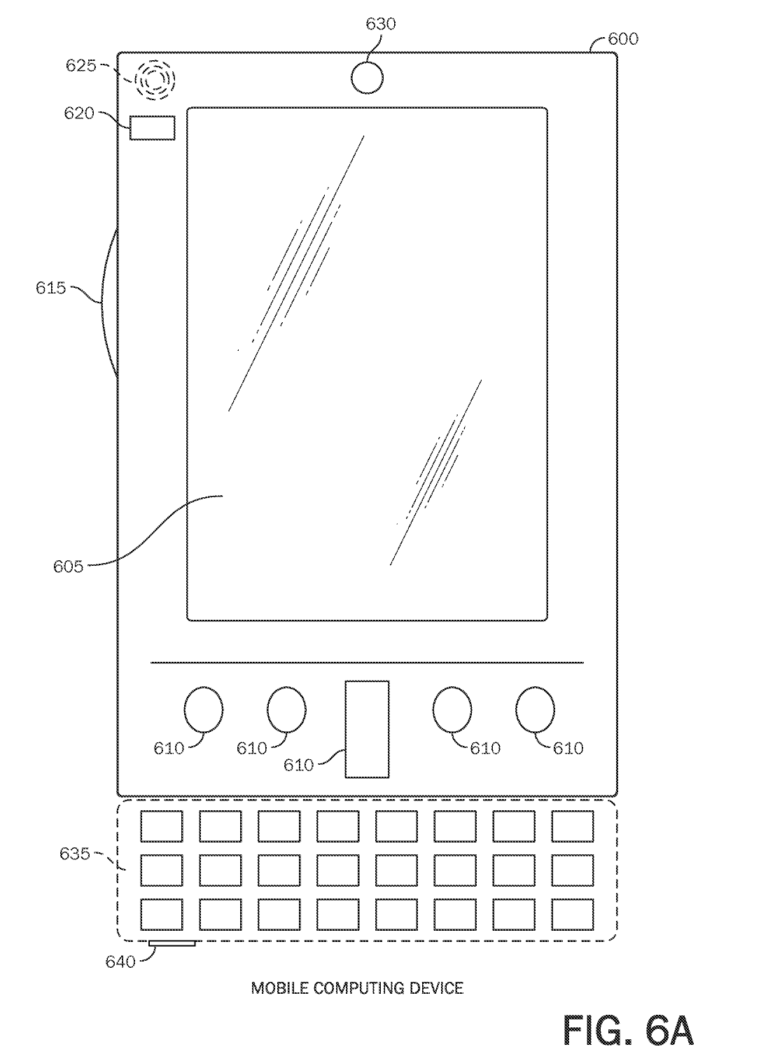

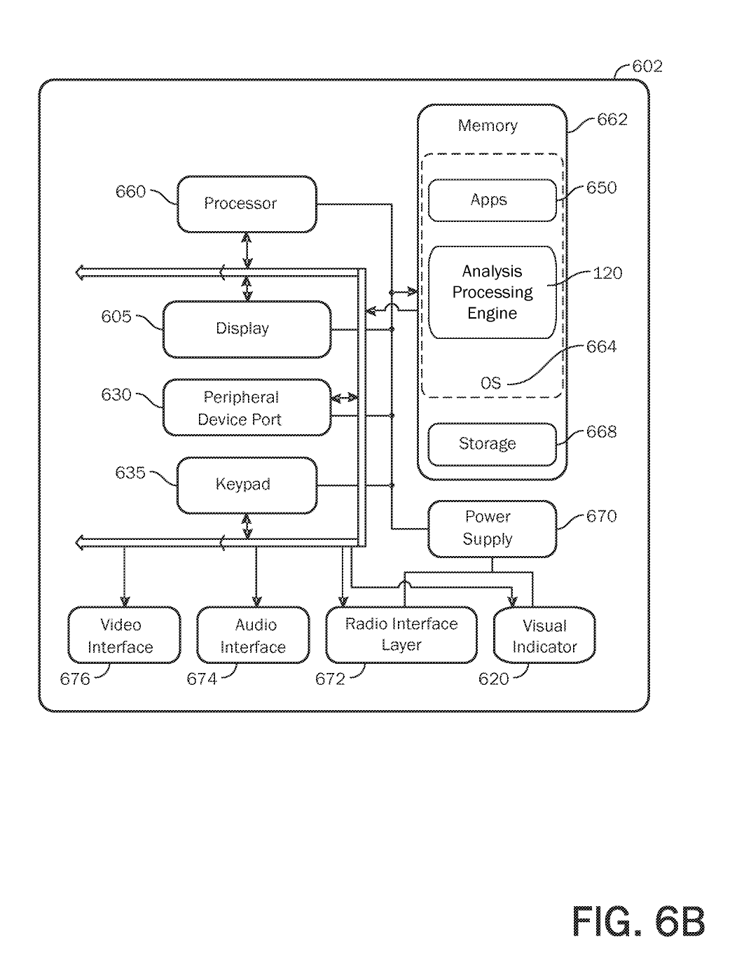

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or less input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, analysis processing engine 120 is loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 is stored locally on the mobile computing device 600, as described above. According to another aspect, the data is stored on any number of storage media that is accessible by the device via the radio 672 or via a wired connection between the mobile computing device 600 and a separate computing device associated with the mobile computing device 600, for example, a server computer in a distributed computing network, such as the Internet. As should be appreciated such data/information is accessible via the mobile computing device 600 via the radio 672 or via a distributed computing network. Similarly, according to an aspect, such data/information is readily transferred between computing devices for storage and use according to well-known data/information transfer and storage means, including electronic mail and collaborative data/information sharing systems.

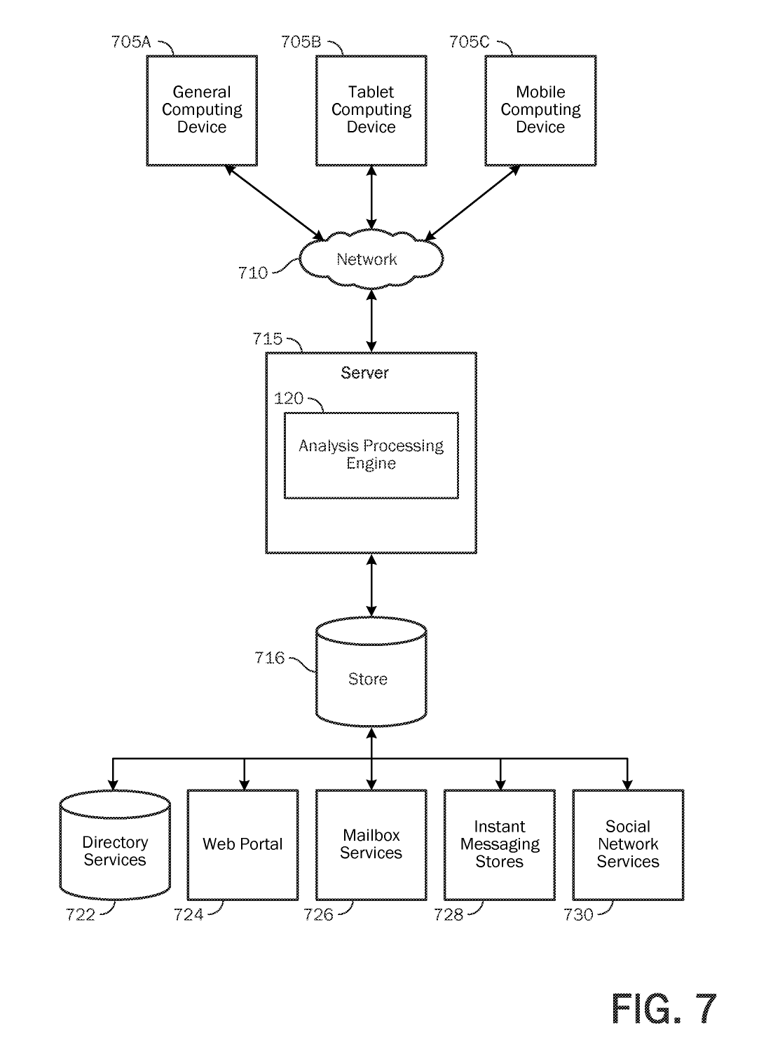

FIG. 7 illustrates one example of the architecture of a system for identifying experts and areas of expertise in an organization as described above. Content developed, interacted with, or edited in association with the analysis processing engine 120 is enabled to be stored in different communication channels or other storage types. For example, various documents may be stored using a directory service 722, a web portal 724, a mailbox service 726, an instant messaging store 728, or a social networking site 730. The analysis processing engine 120 is operable to use any of these types of systems or the like for identifying experts and areas of expertise, as described herein. According to an aspect, a server 715 provides the analysis processing engine 120 to clients 705A,B,C. As one example, the server 715 is a web server providing the analysis processing engine 120 over the web. The server 715 provides the analysis processing engine 120 over the web to clients 705 through a network 710. By way of example, the client computing device is implemented and embodied in a personal computer 705A, a tablet computing device 705B or a mobile computing device 705C (e.g., a smart phone), or other computing device. Any of these examples of the client computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for identifying experts in an organization, comprising:
identifying an area of expertise;
storing the area of expertise as a node in a graph structure;
performing a query for information items associated with the identified area of expertise;
generating a score for each author of each information item associated with the identified area of expertise;
ranking the authors associated with the identified area of expertise;
selecting a subset of top ranking authors associated with the identified area of expertise;
determining whether each of the top ranking authors associated with the identified area of expertise is represented as a node in the graph structure;
if a top ranking author associated with the identified area of expertise is not represented as a node in the graph structure, generating and storing a node representative of the top ranking author in the graph structure; and
generating and storing an edge connecting each of the nodes representing the top ranking authors with the area of expertise node in the graph structure.

2. The method of claim 1, wherein identifying an area of expertise comprising one of:
receiving a manual input of the area of expertise; or
automatically identifying the area of expertise from a corpus of information items.

3. The method of claim 2, wherein automatically identifying the area of expertise from the corpus of information items comprises:
receiving textual data associated with the corpus of information items;
transforming the textual data into a set of terms which can be used as input for further processing;
processing the set of terms to generate a ranked set of keywords or keyphrases; and
selecting a subset of the ranked set of keywords or keyphrases as one or more areas of expertise.

4. The method of claim 3, wherein transforming the textual data into the set of terms which can be used as input for further processing comprises employing one or more of:
tokenization;
lemmatization; and
stopwords removal.

5. The method of claim 3, wherein processing the set of terms to generate a ranked set of keywords or keyphrases comprises:
applying a term frequency—inverse document frequency algorithm and a statistical word co-occurrence algorithm to titles of the corpus of information items;
applying the term frequency—inverse document frequency algorithm and the statistical word co-occurrence algorithm to bodies of the corpus of information items;
generating a set of keywords or keyphrases from the titles of the corpus of information items as determined by the term frequency—inverse document frequency algorithm, the set of keywords or keyphrases comprising a level of importance;
generating a set of keywords or keyphrases from the bodies of the corpus of information items as determined by the term frequency—inverse document frequency algorithm, the set of keywords or keyphrases comprising a level of importance;
generating a set of keywords or keyphrases from the titles of the corpus of information items as determined by the statistical word co-occurrence algorithm, the set of keywords or keyphrases comprising a level of importance;
generating a set of keywords or keyphrases from the bodies of the corpus of information items as determined by the statistical word co-occurrence algorithm, the set of keywords or keyphrases comprising a level of importance; and
merging the sets of keywords or keyphrases into a ranked set of keywords or keyphrases.

6. The method of claim 1, wherein generating and storing the edge connecting each of the nodes representing the top ranking authors with the area of expertise node in the graph structure comprises generating and storing a bidirectional edge.

7. The method of claim 1, further comprising:
receiving an indication of a query for one of:
an expert in a specific area of expertise; or
an area of expertise held by a specific person;
querying a search index associated with the graph structure for retrieving expert and expertise information associated with the edges connecting the nodes representing the top ranking authors with the area of expertise node in the graph structure; and
generating a response including one of:
one of the top ranking authors is an expert in the identified area of expertise; or
the area of expertise is held by one or more of the top ranking authors.

8. A system for identifying experts in an organization, comprising:
one or more processors for executing programmed instructions;
memory, coupled to the one or more processors, for storing program instruction steps for execution by the computer processor;
an expert module for generating a set of experts of an area of expertise, the expert module comprising:
a query component for performing a query for information items associated with the area of expertise;
a scoring component for:
generating a score for each author of each information item associated with the area of expertise; and
ranking the authors associated with the area of expertise;
selecting a subset of top ranking authors associated with the area of expertise;
an output component for:
determining whether each of the top ranking authors associated with the area of expertise is represented as a node in the graph structure;
if a top ranking author associated with the identified area of expertise is not represented as a node in the graph structure, generating and storing a node representative of the top ranking author in the graph structure; and
generating and storing an edge connecting each of the nodes representing the top ranking authors with the area of expertise node in the graph structure.

9. The system of claim 8, further comprising an area of expertise module for identifying the area of expertise, the area of expertise module comprising:
a data mining component for receiving textual data associated with a corpus of information items;
a text processing component for transforming the textual data into a set of terms which can be used as input for further processing;
a ranking component for generating a ranked set of keywords or keyphrases from the set of terms; and
an output component for:
selecting a subset of the ranked set of keywords or keyphrases as one or more areas of expertise; and
storing the one or more areas of expertise as one or more nodes in the graph structure.

10. The system of claim 9, wherein the text processing component uses one or more preprocessing functions, the one or more preprocessing functions comprising:
a tokenization function;
a lemmatization function; or
a stopwords removal function.

11. The system of claim 9, wherein the ranking component is operable to:
apply a term frequency—inverse document frequency algorithm and a statistical word co-occurrence algorithm to titles of the corpus of information items;
apply the term frequency—inverse document frequency algorithm and the statistical word co-occurrence algorithm to bodies of the corpus of information items; and
generate a plurality of sets of keywords and keyphrases, wherein each keyword or keyphrase includes a level of importance.

12. The system of claim 11, further comprising a merger component operable to merge the plurality of sets of keywords and keyphrases into a ranked set of keywords or keyphrases.

13. The system of claim 9, wherein in receiving textual data associated with a corpus of information items, the data mining component is operable to retrieve information items from at least one of:
data repositories;
the graph structure; and
a search index associated with the graph structure.

14. The system of claim 8, further comprising an area of expertise input component for receiving a manual input of the area of expertise.

15. The system of claim 8, wherein in generating a score for each author of each information item associated with the area of expertise, the scoring component is operable to generate a score based on:
applying a weight if the information item includes the area of expertise;
applying a weight if a summary of the information item includes the area of expertise;
applying a weight if a title of the information item includes the area of expertise; and
applying a weight if the author is a creator of the information item.

16. The system of claim 8, further comprising:
a search index for:
receiving an indication of a query for one of:
an expert in a specific area of expertise; or
an area of expertise held by a specific person;
retrieving expert and expertise information associated with the edges connecting the nodes representing the top ranking authors with the area of expertise node in the graph structure; and
generating a response including one of:
one of the top ranking authors is an expert in the identified area of expertise; or
the area of expertise is held by one or more of the top ranking authors.

17. One or more computer storage media storing computer-usable instructions that, when used by one or more computing devices, cause the one or more computing devices to perform a method for identifying experts and areas of expertise in an organization, the method comprising:
receiving textual data associated with a corpus of information items;
transforming the textual data into a set of terms which can be used as input for further processing;
processing the set of terms to generate a ranked set of keywords or keyphrases;
selecting a subset of the ranked set of keywords or keyphrases as one or more areas of expertise;
storing each of the one or more areas of expertise as a node in a graph structure;
performing a query for information items associated with each of the one or more areas of expertise;
generating a score for each author of each information item associated with each of the one or more areas of expertise;
ranking the authors associated with the one or more areas of expertise;
selecting a subset of top ranking authors associated with each of the one or more areas of expertise;
generating and storing a node for each of the top ranking authors associated with each of the one or more areas of expertise in the graph structure if a node does not already exist; and
generating and storing bidirectional edges connecting each of the nodes representing the top ranking authors with the corresponding area of expertise nodes in the graph structure.

18. The one or more computer storage media of claim 17, wherein processing the set of terms to generate a ranked set of keywords or keyphrases comprises:
applying a term frequency—inverse document frequency algorithm to titles of the corpus of information items;
applying the term frequency—inverse document frequency algorithm to bodies of the corpus of information items;
applying a statistical word co-occurrence algorithm to titles of the corpus of information items;
applying the statistical word co-occurrence algorithm to bodies of the corpus of information items; and
generating a plurality of sets of keywords or keyphrases, wherein each keyword or keyphrase includes a level of importance.

19. The one or more computer storage media of claim 17, wherein generating a score for each author of each information item associated with each of the one or more areas of expertise comprises:
applying a weight if the information item includes one of the one or more areas of expertise;
applying a weight if a summary of the information item includes one of the one or more areas of expertise;
applying a weight if a title of the information item includes one of the one or more areas of expertise; and
applying a weight if the author is a creator of the information item.

20. The one or more computer storage media of claim 17, further comprising:
receiving an indication of a query for one of:
an expert in a specific area of expertise; or
an area of expertise held by a specific person;
querying the graph structure for expert and expertise information associated with the bidirectional edges connecting the nodes representing the top ranking authors with the area of expertise nodes in the graph structure; and
generating a response including one of:
one of the top ranking authors is an expert in the specific area of expertise; or
one or more areas of expertise are held by the specific person.
